(19) United States
(12) Patent Application Publication
(10) Pub. No.: US 2013/0268957 A1
(43) Pub. Date: Oct. 10, 2013

(54) METHOD FOR SCHEDULING TELEVISION PROGRAM RECORDINGS FOR A USER

(71) Applicants: Muy-Chu Ly, Palaiseau (FR); Abdelkader Outtagarts, Antony (FR)

(72) Inventors: Muy-Chu Ly, Palaiseau (FR); Abdelkader Outtagarts, Antony (FR)

(73) Assignee: ALCATEL LUCENT, Paris (FR)

(21) Appl. No.: 13/811,038

(22) PCT Filed: Jul. 13, 2011
(86) PCT No.: PCT/FR2011/051679

§ 371 Date: Jun. 6, 2013

(30) Foreign Application Priority Data
Jul. 19, 2010 (FR) 1003033

(51) Int. Cl. H04N 21/262

(52) U.S. Cl. CPC H04N 21/262
USPC 725/13; 725/14

(57) ABSTRACT

The invention pertains to a method for scheduling television program recordings for a user (1), said method providing for:
saving a history of television program recordings by said user in a database (3);
analyzing said history in order to deduce said user's favorite television programs;
generating television program recommendations to be recorded for said user based on said analysis;
scheduling television program recordings based on said recommendations.

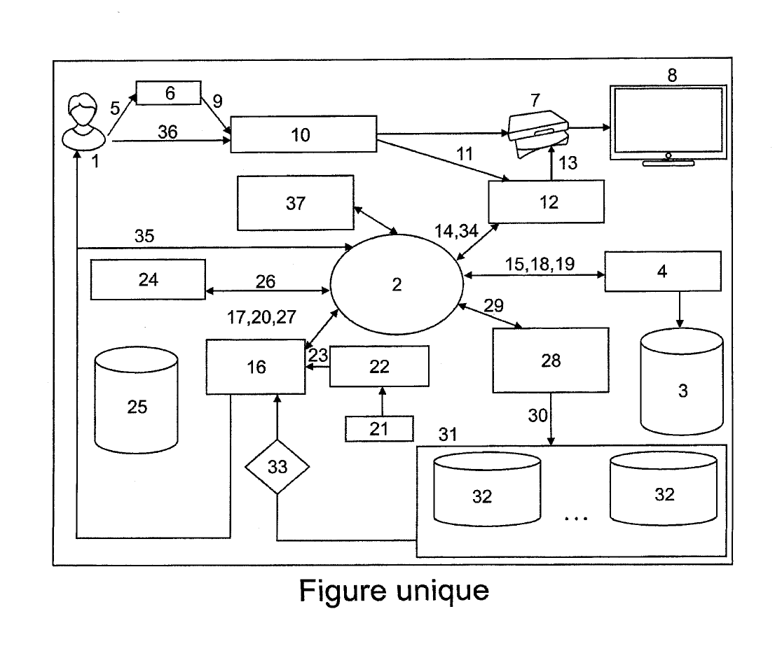

The invention pertains to a method for scheduling television program recordings for a user, an architecture for implementing such a method, and a module for managing such an architecture.

Whenever a user cannot watch a television program at the time it is broadcast, he or she may manually record said program, for example, on the hard drive of a box connected to his or her television set (a set-top box), in order to watch it later.

To do so, the user must know with accuracy the time when the television program that he or she wants to record starts and ends, as well as the television channel on which said program is broadcast. He or she may obtain this information by consulting, for example, an Electronic Program Guide (EPG).

However, it is not always possible for the user to schedule the recording of his or her television program on time, particularly when said user is too busy or whenever he or she is not home at the time when said program is broadcast, or simply whenever he or she forgets to schedule said recording.

Some applications enable a user to remotely manage the recording of his or her favorite television programs from his or her mobile terminal to a set-top box, said box potentially being, for example, a Freebox® from the company Free®.

Among these applications are FreeGo® for the Apple® iPhone®, which additionally enables a user to remotely manage his or her voicemail, as well as the applications Freebox Mobile® and Freebox Recorder® designed for mobile terminals made by the group HTC® (for High Tech Computer Corporation) that integrate the Android® operating system, the application Freebox Recorder® being limited to managing recordings.

However, these applications are not fully satisfactory in that the user must consult an electronic program guide in order to be able to schedule the recording of his or her favorite television programs, with the risk of not being able to do so on time.

The document CN-10 134 5868 presents a method for sharing media data, wherein a networked television terminal receives media data sent via said network or by a local recording terminal or by an audio/video reception device, said terminal then transmitting said media data to said network, so that the device that wants to share said data obtains it from said network in order to perform said sharing.

Furthermore, this document proposes improving the efficiency of media data exchanges, particularly by guaranteeing real-time exchanges.

This solution exhibits a major drawback, in that no recording can be shared in the event that the central network fails or is congested. Furthermore, the desired recording may be made by anyone.

The document US-2009/0178071 discloses a system capable of measuring the viewing frequency of a given television program by a user, in order to identify said program as being a favorite program of said user based on said frequency and of automatically recording said identified program without the user's intervention.

However, with this solution, the memory of the user's recording terminals quickly fills up, particularly when said user watches a lot of television or when multiple members of the same family share the same television set.

The invention aims to perfect the prior art by particularly proposing a method enabling the user to record his or her favorite television programs without needing to consult the program guide, and therefore with a lower risk of forgetting.

To that end, according to a first aspect, the invention proposes a method for scheduling television program recordings for a user, said method providing for:
saving a history of television program recordings by said user in a database;
analyzing said history in order to deduce said user's favorite television programs;
generating television program recommendations to be recorded for said user based on said analysis;
scheduling television program recordings based on said recommendations.

According to a second aspect, the invention proposes an architecture for scheduling television program recordings for a user, said architecture comprising:
a module for managing said schedule;
a module for saving a history of television program recordings by said user, said module comprising a database;
a module for analyzing said history comprising means of deducing said user's favorite programs and means of generating recommendations of television programs to be recorded for said user based on said analysis;
a module for scheduling recommended television programs based on said recommendations.

According to a third aspect, the invention proposes a module for managing such a scheduling architecture, said module comprising means of interacting with other modules of said architecture in order to schedule television program recordings for a user.

Other features and advantages of the invention will become apparent in the following description, made with reference to the attached FIGURE depicting an architecture for scheduling television program recordings for a user according to one embodiment of the invention.

In connection with said FIGURE, below is described an architecture for scheduling television program recordings for a user 1, particularly based on said user's implicit and/or explicit centers of interest, said scheduling also potentially being automatic or semi-automatic.

This architecture comprises a module 2 for managing the scheduling of television program recordings for a user 1. This module 2 comprises means of interacting with other modules of the architecture in order to schedule television program recordings for a user 1.

The method provides for saving the history of the television program recordings by the user in a database 3. To do so, the architecture comprises a module 4 for saving such a history, said module comprising such a database 3.

In order to manually record a television program, the user 1 may, for example, consult an electronic program guide (EPG) by sending a request 5 to a module 6 that provides such a guide, and selecting within said guide's graphical user interface (GUI) said television program, for example by means of a device for remotely controlling the box 7 connected to his or her television set 8, or by means of a mobile terminal (not depicted).

According to one embodiment that is not depicted, the user 1 may also manually save a television program without consulting a program guide, for example a television program being broadcast on the television channel that said user is watching at the time of said broadcast. To do so, the user 1 may simply record the television program by pressing, for example, the “record current” button of the device for remotely controlling the box 7.

Once the user 1 has selected a television program to be recorded, the module 6 that provides a program guide sends a notification 9 of said selection to a recording module 10, for example one that records digital video recordings (DVR, for Digital Video Recorder), of the architecture.

The module 10 then send the notification 11 to a module 12 for scheduling television program recordings of the architecture. The scheduling module 12 comprises means for storing the scheduled recording of the selected television program and means for sending a notification 13 to the box 7 at the time when said program starts broadcasting in order for said box to record said program.

Furthermore, the scheduling module 12 comprises means for sending a notification 14 of the recording of a television program to the management module 2. In such a case, the module's 2 means of interaction are capable of sending a notification 15 comprising information about said recorded program and/or said recording to the module 4, so that the module 4 can save said information in a history of television program recordings by the user 1.

The information saved by the module 4 for a television program recorded by the user 1 may comprise, for example, said program's content identifier number (ISAN, for International Standard Audiovisual Number) and/or the identifier number code of the provider of said program/content identifier number of said provider, the title of said program, the actors' names, the film genre, the director's name, the language, the production date, the producer's name, the category, the user's identifier, the recording start date, the length of said recording, or a summary of said program.

The method provides for analyzing the history of television program recordings by the user 1 in order to deduce said user's favorite television programs; to do so, the architecture comprises a module 16 for analyzing said history, comprising means of deducing the user's 1 favorite programs.

In connection with the FIGURE, the analysis module 16 comprises means for sending a request 17 to the management module 2 in order to get the history of the user's 1 recordings. In such a case, the module's 2 means of interaction are capable of sending a request 18 to the module 4 that saves a history, said saving module responding to the request 18 with a notification 19 comprising said history. Additionally, the module's 2 means of interaction are capable of sending a notification 20 comprising said history to the analysis module 16.

In particular, the method may provide for producing at least one characteristic based on the analysis of the history, in order to deduce the user's 1 favorite television programs based on said implicit characteristic.

To do so, the analysis module 16 may comprise means of producing such an implicit characteristic based on a history. The module's 16 means of deduction may be capable of deducing the user's favorite television programs based on the implicit characteristic, for example by means of an algorithm based on a grouping method, such as an algorithm using a vector similarity tree.

The implicit characteristic may pertain to a piece of information shared by at least two television program recordings included in the history. For example, if the user 1 has recorded multiple soccer-related television programs, the module's 16 means of deduction are able to deduce that soccer-related television programs are the user's 1 favorite programs.

The method provides for generating recommendations of television programs to be recorded for the user 1 based on the analysis of the history of recordings made by said user; to do so, the analysis module 16 comprises means of generating such recommendations.

In connection with the FIGURE, the architecture comprises a module 21 for storing a program guide and a module 22 for extracting information, which comprises means for extracting from the program guide stored in the module 21 information about television programs that are to be broadcast and are included in said guide.

Furthermore, the module 22 comprises means capable of sending the module 16 a notification 23 comprising information about the television programs that are to be broadcast, so that the module's 16 means of generating generate television program recommendations to be recorded for the user 1 based on said information and on the analysis of the history of said user's recordings.

According to one embodiment, the method may also provide that the user 1 specifies at least one explicit characteristic, particularly related to his or her senders of interest and in the form of a keyword, in order to refine the recommendations generated for said user by using said explicit characteristic.

To do so, the architecture comprises a configuration module 24 that comprises means for enabling the user 1 to specify such an explicit characteristic, particularly with respect to at least one piece of information about a favorite television program of said user.

Once the user 1 has specified an explicit characteristic, the module 24 stores said explicit characteristic in a database 25 and sends a notification 26 comprising said explicit characteristic to the module 2, the module 2's means of interaction being capable of sending a notification 27 comprising said explicit characteristic to the analysis module 16.

Furthermore, the means of generating the module 16 are capable of refining the recommendations generated by the use of such an explicit characteristic.

According to one embodiment, the module's 16 means of deduction may also be capable of producing the user's 1 favorite television programs based on at least one explicit characteristics specified by said user.

Furthermore, the method may provide storing the recommendations generated within at least one database in view of sharing them with at least one other user.

In connection with the FIGURE, the architecture may comprise a sharing module 28 comprising a database within which the generated recommendations may be stored in view of sharing them with at least one other user.

In particular, recommendations generated for the user 1 may be shared with another user belonging to the same community as the user 1, particularly a community of a social network such as Facebook® or Twitter®.

In order to do so, the module's 2 means of interaction may be capable of sending the module 28 a notification 29 comprising at least one recommendation to be shared and the module 28 may comprise means for sending a notification 30 comprising at least one such recommendation to a server 31 for providing a social network, said server comprising at least one database 32 specific to the community to which the user 1 belongs and in which said recommendation is stored, so that the other users who are members of that community can access said recommendation. Thus, the method makes it possible to enhance the recommendations shared within a community to which the user 1 belongs.

Furthermore, the configuration module 24 may comprise means for enabling the user 1 to define, activate, or deactivate a way of sharing his or her generated recommendations with at least one other user.

To do so, the module's 24 means may be capable of enabling the user 1 to configure a mode for sharing his or her generated recommendations, for example by entering the names of the other users of the community with which he or she wishes to perform such sharing, then of enabling set user to activate or deactivate said configured mode.

Likewise, the method may provide for expanding the recommendations generated for the user 1 based on the recommendations shared by at least one community to which the user 1 belongs.

In particular, the user 1 may share recommendations generated for another user belonging to the same community as said user. To do so, the architecture may comprise a module 33 capable of transmitting recommendations stored in a database 32 of the community to the analysis module 16, said analysis module's means a generation being capable of pooling said recommendations transmitted with the recommendations generated for the user 1, particularly in order to avoid duplicate recommendations.

The method provides for scheduling television program recordings based on the recommendations for the user. To do so, the scheduling module 12 comprises means for scheduling such recordings based on such recommendations.

In connection with the FIGURE, the module's 2 means of interaction are capable of sending the scheduling module 12 a notification 34 comprising television program recommendations previously sent by the module 16 to the module 2 in a notification 35, the module 12 then sending the box 7 a notification 13 at the start time of the recommended television programs' broadcast, so that said box can record them.

This way, the method enables a user 1 to automatically schedule the recordings of his or her favorite television programs and/or television programs enjoyed by other users belonging to the same community as the user 1, which are therefore likely to be enjoyed by the user 1 if said community groups together users who have similar tastes in television programs, without needing to consult a program guide.

Furthermore, the method may provide for an intervention by the user 1 in order to confirm the recommendations prior to the scheduling of the recommended television program recordings, e.g. to avoid filling up the hard drive of the user's box 7 too quickly, and thereby keeping said user from missing the recording of a television program that particularly interests him or her.

To do so, the configuration module 24 may comprise means for enabling the user 1 to select a mode for scheduling the recommended television program recordings. For example, the module 24 may offer the user 1 in automatic mode corresponding to automatic scheduling, a semi automatic mode in which the television program recommendations are first submitted to the user 1 and a manual mode in which the method does not apply, with the user 1 recording television programs by consulting a programming guide.

In order to view his or her recommendations, the user 1 sends a request 34 to the recording module 10, said module comprising means of interaction with a module 37 that provides a programming interface (API, for Application Programming Interface).

Furthermore, the module's 2 means of interaction are capable of interacting with the module 37 and with the module 16 and/or the module 4 in order to provide the module 10 with a list of program recommendations and/or a list summarizing the history of recordings made by the user, such lists being displayed on the user's television set 8, for example on a graphical user interface provided by the box 7.

Furthermore, the recommendations may be displayed on the television set 8 in the form of lists of information about the recommended program, said information potentially relating in particular to characteristic specific to the preferences of the user 1.

The user may then validate the recommendations of his or her choice, for example by means of a remote control device of the box 7, the module 10 sending the module 12 notification 11 for each of the validated recommendations, so that the module 12 sense, for each recording thereby scheduled, a notification 13 to the box 7 in order to record the corresponding television program.

1. A method for scheduling television program recordings for a user, said method providing for:
saving a history of television program recordings by said user in a database;
analyzing said history in order to deduce said user's favorite television programs;
generating television program recommendations to be recorded for said user based on said analysis;
scheduling television program recordings based on said recommendations.

2. A scheduling method according to claim 1, wherein it provides for storing the generating recommendations in at least one database in view of sharing them with at least one other user.

3. A scheduling method according to claim 1, wherein it provides for enhancing the recommendations generated for the user based on the recommendations shared by at least one community to which the user belongs.

4. A scheduling method according to claim 1, wherein it provides for an intervention by the user in order to validate the recommendations prior to scheduling the recommended television program recordings.

5. A scheduling method according to claim 1, wherein the user specifies at least one explicit characteristic, the recommendations being refined by the use of said explicit characteristic.

6. A scheduling method according to claim 1, wherein it provides for producing at least one implicit characteristic based on the analysis of the history, the user's favorite television programs being deduced based on said implicit characteristic.

7. An architecture for scheduling television program recordings for a user, said architecture comprising:
a module for managing said scheduling;
a module for saving a history of television program recordings by said user, said module comprising a database;
a module for analyzing said history comprising means of deducing said user's favorite programs and means of generating recommendations of television programs to be recorded for said user based on said analysis;
a module for scheduling recommended television programs based on said recommendations.

8. A scheduling architecture according to claim 7, wherein it comprises a sharing module comprising a database in which the generated recommendations are stored so that they can be shared with at least one other user.

9. A scheduling architecture according to claim 7, wherein it comprises a configuration module that comprises means in order to allow the user to specify at least one explicit characteristic, the analysis module's means of generation being capable of refining the recommendations generated by the use of said explicit characteristic.

10. A scheduling architecture according to claim 7, wherein the analysis module comprises means of producing at least one implicit characteristic based on the analysis of the history, the means of deduction being capable of deducing favorite television programs based on said implicit characteristic.

11. A management module of a scheduling architecture according to claim 7, said module comprising means of interaction with other modules of said architecture in order to schedule television program recordings for a user.
